(19) United States
(12) Patent Application Publication
(10) Pub. No.: US 2026/0347631 A1
(43) Pub. Date: Nov. 5, 2026

(54) SECURITY EMBOSSED PRINTING INK USED FOR DOCUMENTS AND PACKAGING AGAINST FORGERY WITH EMBOSSED PRINTING

(71) Applicant: SAM SECURITY PRINTING MATBAA ANONIM SIRKETI, Sariyer/Istanbul (TR)

(72) Inventor: Hassan Mamizadeh, Kartal/Istanbul (TR)

(21) Appl. No.: 19/478,437

(22) PCT Filed: Oct. 30, 2023
(86) PCT No.: PCT/TR2023/051221

§ 371 Date: Oct. 24, 2025

(30) Foreign Application Priority Data
Apr. 28, 2023 (TR) 2023/004788

(51) Int. Cl. C09D 11/101; B41M 1/10; B41M 3/14; B41M 7/00; B42D 25/378; C09D 11/108

(52) U.S. Cl. CPC C09D 11/101; B41M 1/10; B41M 3/14; B41M 7/0081; C09D 11/108; B42D 25/378

(57) ABSTRACT

A security embossed printing ink which can be used in dry offset and normal offset printing systems and inkjet offset digital printing systems to promote a wide market such as industrial and commercial packaging, food, pharmaceuticals, health, cosmetics, especially on paper and sheets, which can be used for documents and packaging against forgery with embossed printing in the field of printing, which provides a significant reduction in costs by obtaining the desired products in one time, and includes an ink composition containing at least one UV curable photopolymerization initiator material, at least one filling material with thickening properties, at least one polymer material, at least one antistatic material, at least one antioxidant ingredient, at least one UV-blocking material, aerosol as at least one moisture-retaining and anti-condensation material, at least one additive with wetting, dispersing, leveling, anti-foaming, rheology modifying properties, at least one curing agent, and at least one color pigment.

### BACKGROUND OF THE INVENTION

### Field of the Invention

This invention relates to security embossed printing ink used for documents and packaging against forgery with embossed printing that allows for more precise embossed printing, that dries easily, that does not provide its embossment from the pressure applied to the paper, that embosses 100% with the ink, that prevents leakage in the inks after printing, that allows the printing of valuable documents or packaging in the security printing area, that is a new ink whose printing type and display is the same as embossed printing with more efficient and optimal changes, that is used for embossed printing in the printing area and has the characteristics of dry ink, and that is suitable for long-term use without degradation.

### Description of Related Art

Today, document forgery is a major problem. To solve this problem, industry and government owners are losing 800 billion dollars a year in financial losses, resulting in the loss of jobs of one hundred thousands of people every year in Europe alone. This is considered a very interesting challenge for the government and for any research and development company. In 1981, the US Federal Police pursued 1.825 cases of document forgery and fraud over 100,000 dollars. This number increased to 26.931 cases in 1991 and exceeded 280.000 cases in 2003.

These statistics are not yet fully available in our country. As a result of such alarming statistics, it is necessary to solve this problem. The success of reaching a solution to this problem is of great importance for those seeking a solution. Again, it is valuable for many producers of goods and services. It is therefore not surprising that there are many efforts to provide different solutions to prevent forgery of documents and security papers. Companies protect their trade name and identity through the packaging of their products.

Secure printing is a growing market for both criminals and industry owners and consumers of these print orders. Those who engage in this type of forgery have access to advanced technologies every day. This necessitates the need for new inventions in this field. There are many ways to access products which are new, secure and which prevent forgery.

However, a unique technology cannot meet all the needs of the consumer. For this, the end consumer or general public needs to be educated. For this, consumers must be able to identify the security methods used. In any case, technological developments and innovations in the field of security printing are gaining a new dimension and progressing every day. However, this is not a source of hope alone. It is important that experts and researchers work together with manufacturers. For security printing systems and processes; intelligence, security forces and police need to exchange ideas and information to stay one step ahead of forgers and criminals.

The need for “intaglio printing” or “copperplate” printing processes today to achieve all these aims is well known to those specialized in the field of security printing. The printing plates (printing blocks) used; chrome plates, nickel plates, engraved plates are engraved by hand or with acid or laser. The mentioned aspects of gravure printing processes are based on the same technology as the printing of documents, banknotes and security papers, printing systems, machines and engraved plates and plates and engraved printing inks from the beginning of the first half of the 18th century to the present day, i.e. at the beginning of the 21st century, which is in some way based on engraved printing inks. Consequently, construction and production entail enormous costs.

A brief review of the history of printing shows that the inventor of the printing machine was German. In ancient Babylon, 3000-1000 BC, people used to print their signatures by painting stone seals. This is the first example of gravure printing. In ancient Rome, slaves copied manuscripts. AD-500, the Chinese made prints using a carved block of wood. AD-1000 Buddhists printed Tripitaka texts using wooden blocks. In 1040, in the 11th century, a Chinese printer named Bisheng invented the idea of movable type printing. This allowed them to make many small clay blocks. Each one had a different letter or sign. He used them to organize them in the printing frame and in this way they were able to print many things. Unfortunately, because there were thousands of characters in the Chinese language and literature, this idea did not gain much traction and did not develop quickly. Printmakers preferred to use the same engraving method on wood. In 1300, block printing was first used in Europe. In 1450 Johannes Gutenberg built the first modern printing press using a portable metal typewriter. From this point of view, Johannes Gutenberg did not invent the printing press and the portable typewriter, but he brought these two together and introduced a new printing method. This idea was accepted and used all over the world. In 1456 Gutenberg printed Gutenberg's famous Bible. In the year of 1500 Gutenberg's method had been used on thousands of printing presses and millions of books had been printed with it. Gutenberg took the achievements and techniques of his predecessors from different centuries and combined them to invent a new method. It has been used as the basis of the permanent printing system to this day. The primitive printing device invented by Gutenberg was of low quality and was gradually improved over time. Johannes Gutenberg invented the printing device with German characters. In this way, Gutenberg invented and developed the printing press.

Word printing means to press in Latin. This is because all printing systems involve printing one thing into another. Printing is a difficult physical task and is usually done with the help of a machine called a printing press. Various printing systems can be mentioned.

Letterpress printing, engraving printing and offset printing are three common printing methods. In all three methods, ink or any other material is easily transferred from the printing plate to the paper. However, the function of each is slightly different from the other.

Letterpress printing is high printing with metal letters (type). It requires a long and laborious printing preparation process. The method of arranging the metal letters to form individual pages is used. Although the print preparation process has improved, it is far from the possibilities provided by today's desktop publishing system. There are two cylinders in letterpress printing. One of them is the mold cylinder and the other is the printing cylinder. It is a direct printing system in which the image on the plate is transferred directly to the printing material. While the high parts on the mold receive the ink, the low parts do not receive the ink. The high parts realize the printing; in this respect, it is similar to potato printing. The image on the mold is reversed. In letterpress printing, the image area is higher than the non-image area. For example; when an old typewriter is used, this printing method is actually considered to be used. Letterpress printing is the oldest printing method. Today, its use has been left to a significant extent. For example; when an old typewriter is used, this printing method is actually considered to be used. Letterpress printing is the oldest printing method. Today, its use has been left to a significant extent. It is rarely used for printing business cards, invoices and special collection publications. Letterpress printing machines are mostly used in printing; cutting, embossing, number printing, pleating-perforating serve in other fields.

Engraving can be called a form of engraving, intaglio printing or etching. The image to be printed is transferred onto a wooden, metal or stone plate using various methods (hand scraping or acid etching) and then the plate is plastered with ink. When the surface of the plate is cleaned, the ink remains only in the pitted areas and the image on the plate is transferred to the paper by printing. Gravure or Intaglio: A common method of security embossed printing with an engraved page. It is the opposite of letterpress printing. Instead of engraving an embossed design on the printed page, the desired image and design is completely engraved on the metal plate. In this method, when a person wants to print, they cover the entire page with ink so that the ink covers all the engraved parts. The printing plate is then completely cleaned until all the ink is removed from the flat part. As a result of this process, some ink remains on the engraved parts. Finally, the page is printed with a lot of pressure on the paper. The paper is therefore pressed against the inked parts and the ink in the engraving is absorbed by the paper. Finally, the design is created on the paper.

Offset is a printing technique. The technique is based on the principle that oil-based printing ink and water do not mix. Founded in 1904 by the American Ira W. Rubel, it is usually applied to the surface of paper (except for tin offset). Today it is used for printing books, newspapers, magazines, brochures, invoices, business cards and cardboard packaging. In offset printing, the object is transferred from the printing plate to the paper, but is printed directly on the paper instead of on the printing plate. The printing plate is pressed onto a soft roller, such as a special rubber roller, and transfers the image to the roller. This rubber roller is then pressed onto the paper and the image is then transferred to the paper.

In this method, the printing plate does not wear out quickly due to the continuous pressure on the paper and the print quality is much higher. This is the most common type of printing today. This method is also known as offset lithography. It is often referred to as offset. Compared to other printing systems, it is very optimal, fast, cheap, high quality, unlimited and unique.

Embossed printing of security papers and documents is one of the obvious and aesthetic security effects. Apart from the security effects and non-counterfeiting conditions, they also have an attractive visual effect. Nowadays, intaglio engraving is mainly used for paper or plastic coins, passports, visas and banknotes. Famous artists of the past also used this type of gravure printing. The paintings of Picasso and Francis Goya are mentioned as examples.

Security printing has its own features. One of the most important features of security machines is that their printed samples cannot be reproduced, scanned or copied.

Printing techniques in this industry include normal offset, waterless offset, flexo, stencil, intaglio and printing machines. Each of the printing techniques used according to the need in each part of the document designed to have the security features of the document produced has advantages and disadvantages.

Among the various inks that can be used in the engraving printing system is the selected system for first-class security documents, where after printing the graphic design, effects such as a noticeable protrusion appear and there is the possibility of scraping after printing (for engraving). Very fine patterns allow the images and texts printed by this printing system to be delivered to the printers. In addition, using this type of combination, one-and two-dimensional secret images or words can be inserted into the document, even in large sizes. The making of engraving printing plates is based on digitally and manually engraving images onto the page surface. Etching inks are water-soluble and become waterproof after drying. Due to shrinkage, the image effects printed with these inks are obvious and visible after drying. Once the engraving inks are fully fixed to the paper, they resist scratching and abrasion for a shorter period of time, and over time, the tangible effects of the engraving are lost or reduced due to damage and abrasion of the paper base layer.

The problem with today's intaglio printing inks is that they dry slowly and are moist, that is, after the embossed printing process, the ink passes from one printed sheet to the back of the next printed sheet (sticking, ink return), in a stack or behind an endless layer in a line, and these factors depend on the type of printing ink formula, gravure depth and uniformity, printing conditions, purity of the print, the number of stacked sheets in each column and time.

In the banknotes shown in FIGS. 8 and 9, the adhesion of the ink remaining on the embossed surface adhering to the back of the next page and the overlapping of the stacks of paper printed after printing due to the contact parts of the embossed images and how to work with them and the abrasion on the back of the top page are slightly tactile, the highlights are lost at the same time and this is called loss of quality. When pressure is applied to the stack of pages printed on each of the obverse and reverse sides of the banknote shown in FIGS. 8 and 9, the affected printed banknote is irreversibly damaged. During primary and secondary control, these damaged pages go through several departmental quality checks after the final printing of the documents. All damaged pages are removed from the cycle and recycled so that they are not sent to the end user. All these processes result in a lack of quality. This lack of quality results in banknote and labor losses and costs as a result of late drying times and poor performance of an ink shown in FIG. 6.3 (ink leaks) due to semi-dry printing for the substrate and mass printing on ink that does not dry.

Due to the unique characteristics of gravure printing, inks used in other printing systems such as offset printing are not used in letterpress printing and the formulations are completely different. Gravure printing is caused by residual adhesion on the surface of the printed sheet, often exacerbated when pressure is applied by the weight of a stack of sheets stacked on top of each other. The drying process is usually worse on paper that goes to the bottom of the stack, because these sheets have the least weight. One method used to reduce the problem is to interleave pages between adjacent pages. However, interleaving is a very cumbersome and expensive process and is not economically viable or desirable for printing operations. The adjustment problem is more pronounced on the substrates side, which cannot easily absorb solvents from the printing ink. Hydrocarbon solvents are used for this situation and other solvents can remain to some extent after the ink has dried. Effectively, solvents can act as softeners and provide more flexibility to the dried ink. These materials appear effective and efficient in the final output conditions of laminated sheet printing due to the pressure of its weight. Sheets stacked on top of each other, apart from the ink returning to the back of the top paper, the pressure applied due to the softness of the newly printed print will also reduce the prominence.

The currently used intaglio engraving ink comprises at least one compound which can be cured with UV, an oxidatively polymerizable compound, a photopolymerization initiator, an oxidative polymerization catalyst and a pigment. In physical appearance, the ink has a paste composition using engraved metal “plates” and a mold, which are often referred to as similar and identical types of intaglio inks in all phases of the numerous patents applied for, all of which use the same process and printing system. These plates are used in all systems, but the inks are evolving day by day to dry faster or to make the lettering more clearly visible.

In earlier printing systems, even if printing is done, it is not done in a modern way, and in this case, errors are seen too much and the system continues more slowly. As noted in history, in 1450 AD, Johannes Gutenberg built the first modern printing press using a portable metal typewriter. He did not invent the printing press or the portable typewriter, but he did produce the printing press. This idea was strongly accepted. The same method and idea was used by printing press manufacturers all over the world. In other words, the functional system of this process was advanced thanks to the same actions and way of thinking as the “German Johannes Gutenberg”. As a combination of the ink used in various printing systems; Intaglio printing system+offset printing system+digital inkjet printing system+electrostatic powder-like dry paint, combining all these and the technology systems used in the industry, 80% of it is the same with composite material of this invention, the base, raw material and polymer pigment of the intaglio inks used, and the intaglio inks are the same and similar to each other, the essence of the substance is the same as gravure printing, and some patent applications known in the literature are given below; it is noted that no prior art cited in the application is incorporated in the invention:

Although the state of the art includes several documents, these documents could not lead the way to the present invention.

EP 4 052 920 A1 relates to a method for numbering of banknotes using laser writing. The method comprises a step of printing onto each of the two surfaces of a substrate one or more printing ink layers, wherein the printing ink of at least one of the printing ink layers comprises at least one pigment and/or at least one dye, which changes its color upon exposition to layer radiation. While the method disclosed is not intended to be limited to a particular printing technique, this document remains silent on embossing inks that emboss with the ink itself.

CN 114379261 relates to decorative screen printing of black cards. Therefore, the printing inks disclosed therein lack several components over the inks of the present invention. Besides, they are subjected to a completely different processes and lower requirements than inks for security printing.

Patent application with the number U.S. Pat. No. 8,636,307B2 describes “Embossed Printing Inks”. The invention relates to printing inks for an intaglio printing process, also referred to as an engraved steel plate printing process.

The patent application with the number JP2002038065A describes “Resin Composition for Intaglio Printing Inks, Ink Composition Made by Using the same and Printed Matter Obtained Therefrom”. The invention provides a resin composition for intaglio printing inks, which makes it possible to remove excess ink with a waterbased wiping liquid and gives an ink having a shaping ability in terms of surface drying by ultraviolet rays.

Patent application with the number W02003066759A1 describes “Embossed Printing-Use Ink Composition and Application”. The invention relates to a embossed printing-use ink composition comprising a embossed printing technology for producing security prints and artistic prints requiring anti-counterfeiting and antimodification, and providing print quality. The invention comprises at least one water-soluble ultraviolet curing composition, oxidation polymeric composition, photopolymerization initiator, oxidation polymerization catalyst and polymerization inhibitor.

In the patent application with the number JP2009227702A, “Intaglio Printing Ink Composition and Printed Matter Obtained by Using the Same” is described. The invention is to improve the adhesion of an ultraviolet-curable, oxidation-polymerizable intaglio printing ink composition to a substrate, such as a plastic, which the ink composition cannot be expected to penetrate. The intaglio printing ink composition comprises at least an ultraviolet curable composition, an oxidation polymerizable composition, a photopolymerization initiator, an oxidation polymerization catalyst and a polymerization inhibitor.

Patent application with the number KR20120095918A describes “Embossed Printing Inks”. The invention describes an intaglio printing ink that causes very little bleeding, exhibits improved chalking resistance and achieves improved print quality, and allows cost-effective prevention of blocking by low-dose irradiation with ultraviolet light.

Patent application with the number WO0138445A1 describes “Intaglio Printing Inks”. The invention describes an intaglio printing ink that uses a self-oxidizable polyester resin as a binder.

When the patent applications described above are examined, in intaglio engraving, a single-sheet printing technique in which printing elements are cut into the surface, a viscous ink fills the recessed areas of the printing plate and is transferred to the substrate under high pressure (80-100 kg/cm2). The pressure pushes the substrate into the recessed areas. Intaglio printing has obvious problems. These problems are: different depth and width of use pressures, deformation of the substrate (protrusion inward from the back side) [FIG.-5.1 (206)], a thick ink layer that provides and creates a wide range of compound transfer, and ink leaks between the paper fibers at the edges of the stroke [FIG.-5.2 (502)].

As a result, there is a need for a new ink that can overcome the mentioned disadvantages, [FIGS.-6.2 and 602] allowing for more precise embossed printing, easy drying, allowing for the printing of valuable documents or packaging in a secure printing area.

### SUMMARY OF THE INVENTION

The present invention is a security embossed printing ink used for documents and packaging against forgery with embossed printing as defined by claim 1, characterized in that it is a new ink that allows for more precise embossed printing, is easy to dry, does not cause embossing from the pressure applied to the paper, embosses 100% with the ink, prevents leakage in the inks after printing, allows printing of valuable documents or packaging in the security printing area, and the type and display of printing is more efficient and the same as embossed printing with optimal changes.

The performance and printing process of the ink which is the subject of the present invention will be used without the need for gravure plates and intaglio machines, and these materials and compounds which are the subject of the present invention are used in the resulting printing system mentioned in the international application by the same inventor HASSAN MAMIZADEH published as WO 2021/014296 A1. The sixth part of the international application WO 2021/014296 A1 is designed for the most important feature of security documents. The use of these materials in the digital security printing ink-jet printing system is described in detail.

Thanks to the ink which is the subject of the present invention, it can also be used in offset printing systems without the need for engraving and lettering plates and intaglio machines. If the ink which is the subject of the present invention is used in the embossing (intaglio) printing system in the embossing (intaglio) printing system itself, gravure plates must be used, but the only difference is that if this ink is used in the system addressed in the international application WO 2021/014296 A1, printing quality, durability and quick drying will be ensured. In particular, it eliminates the problem of applying ink to the upper layers. In the intaglio printing system, only gravure plates are used. However, in the mentioned systems, no plates and gravure plates are used for dry offset/ordinary offset/inkjet digital offset/heliogravure/rotogravure embossed printing. This is the only effectiveness of the ink of the present invention, which is very strong and durable and of better quality than the intaglio system. The present invention does not require very expensive intaglio machines, nor does it require very expensive intaglio engraving plates, which can cause all the problems and issues that cause a lack of quality in printing (such as ink leaks).

With the “UV and IR SYSTEM EMBEDDED IN MOBILE PHONE” with priority number TR 2023/003783 A and whose inventor is HASSAN MAMIZADEH, the control of the products produced with secure printing produced with the ink of the present invention can be easily done by every user, and both inventions are used as complementary to each other. Because with the system disclosed in TR 2023/003783 A, which can be used in mobile phones that everyone has in daily life, users can check whether products that require security such as money, packaging or medicine are fake or not at any time. The quality and clarity of the ink used in these products are also in the security embossed printing ink used for documents and packaging against forgery with embossed printing. In previous systems, the feature of being safe in the packaging sector could not be realized in every packaging due to the cost, and fake products were used too much, but with the security embossed printing ink used for documents and packaging against forgery with embossed printing, it is possible to print on packaging of any fineness, and with the system disclosed in TR 2023/003783 A, the accuracy of all packaging can be checked by users.

The advantages of the present invention are as follows:
In the present invention, more than 95% of the overspray dry ink is optimally recycled, whereas currently used inks such as solvent-based inks such as intaglio inks for use on engraved plates have a special structure and are all patented. The recycling rate for the inks currently used is less than 15%.
There is no precipitation or sedimentation in the present invention.
It plays an important role in promoting the security printing business and provides not only the latest technologies and solutions, but also a platform to exchange views on the challenges faced by security printing customers.
It can be used without the need for engraving plates.
It is used without the need for gelatinous plates.
There is no need for embossing (intaglio) machines, which are the most expensive printing system machines.
In gravure printing, embossing (intaglio) has only been used for embossing in document work, due to the higher costs of tactile embossing ink.
The composition of the present invention can work very strongly in the printing and packaging industry as it is inexpensive and does not involve infrastructure costs such as embossing (intaglio) gravure plates and handling.
Due to the use of this compound composed of micro particles with the system disclosed in the international application WO 2021/014296 A1, a wide range of possibilities can be provided in the printing industry, such as the possibility of printing on thick and thin sheets. Because it can be used in thick packaging such as weighted boxes (50 to 1000 grams).
More substrates are being prepared as the compound of the present invention. Because the use of this compound can be applied in all printing systems, this means a powerful substrate and potential that can be used in all areas of the printing industry.
The most important issue in the field of printing and packaging for products other than the cost of the finished product is more important for the manufacturer as the safety of the finished product. Therefore, the customer's satisfaction can be achieved with the platform created with all these and this is a unique and unrivaled business and competition in terms of trade and business because it is not possible to print gravure printing for thick plates in the industry with the printing system in intaglio printing and it is not possible to print to create security in packaging. For this reason, security printing is not part of the packaging industry. Currently, it is not possible to print for thick plates, but with the present invention, it can be easily used in thick packaging such as weighted boxes (50 to 1000 grams). Thus, it can be used in a wider range of areas for security controls.
In printing with the ink which is the subject of the present invention, it has high printing quality, durability, at least 10 times and more adhesiveness compared to embossing (intaglio) ink.
With the technology created in the inventor's international application WO 2021/014296 A1 and commercialized by the investment company in Turkiye, in addition to embossing (intaglio) printing ink and especially printing ink with serial numbers, all the security inks needed can be printed with the dry ink of the present invention. This embossed printing process is an exceptional and unimaginable system for printing variable information without the need for special metal engraving plates, which are clear and tactile, better quality than previous intaglio engraving printing systems. This system is due to the great power of the dry ink of the present invention, which does not need to be engraved with the substructure of engraving plates.
This dry ink material of the present invention can be used to create relief printing to replace intaglio printing without the need for gravure plates and expensive intaglio machines, it can be used as a pigment and as the basis for any ink that needs pigment in production. It can only be used in specialty inks such as very expensive security inks such as OVI optically variable inks, except for the creation of invisible to visible, thermal, magnetic and embossed printing, but at a maximum of 30% of the total cost. When dry ink materials are added, it will be cheaper than before and in terms of quality it sticks better than before.
Currently, it was not possible to print more than 5 combined colors “5 separate colors that cannot be combined with each other” in the intaglio engraving printing system. However, with the ink which is the subject of the present invention, the system can be borderless and edgeless and has the ability to combine and separate individual prints at the same time with “unlimited” number of colors and it is possible to combine them. With superior quality and high durability, it can be printed as distinctly as intaglio and brings more adhesion than them.
Using the dry ink which is the subject of the present invention, it can be used in dry offset and normal offset printing systems and inkjet offset digital printing systems to promote a wide market such as industrial and commercial packaging, food, medicine, health, cosmetics, especially on paper and sheets. By creating embossed printing from “50 microns to 1000 microns” in large and small thicknesses, forgery is prevented by applying all security elements such as banknotes in packages with urgent security needs.
After the security printing activities, thanks to the ink of the present invention, although it was originally called an ink, it is a revolution that has managed to enter the framework of all dry offset printing systems, normal offset, digital offset. UV inkjets can go a long way in the security printing industry, which can provide inimitable security, which will greatly impact the packaging industry and market, which is full of counterfeit products and can prevent fraud.
Thanks to the use of the ink of the present invention and its low cost, it enters the security printing industry in the field of commercial and industrial, food and pharmaceutical packaging printing. Because counterfeit products can cause losses. Company profits can be affected and low-quality counterfeit products can damage the company's reputation and financial economies. Human life and health can be at risk when it comes to sensitive products such as pharmaceuticals, airplane and car parts. This is because, according to the World Health Organization (WHO), around 100,000 deaths a year in Africa are linked to the trade in counterfeit medicines. The British think tank “International Policy Network” estimates that 700,000 deaths a year worldwide are caused by counterfeit malaria and tuberculosis drugs, comparing the death toll to the equivalent of “four fully loaded jumbo jets crashing every day”. The present invention is being made to solve all these problems, and by preventing the production of counterfeit drugs, the mortality rate will be substantially reduced. The essence of the present invention is that the sixth part of the inkjet UV system used in the special printing system in the field of security printing in the international application WO 2021/014296 A1 is the most important feature of the security document.
Although introduced and used, it is worth noting that this manufacturing process belongs to the inventor and is used in the system disclosed in the international application WO 2021/014296 A1. Due to the exclusivity of the device and the integrity of the manufacturing process with its unique printing system and special inks and compounds, it is more difficult for forgers to forge to ensure an original product and a comfortable purchase for consumers.
The present invention means that greater security can be achieved in the security certificate industry and the packaging industry. According to industry reports, the packaging market segment is growing. According to statistics, the growth of the security printing sector has remained at 10 million dollars for several years, unlike other sectors, this shows that the cost of raw materials such as inks and security machines are very expensive and therefore they have not been able to enter the packaging sector. However, the ink of the present invention is of high quality and durability, and is produced with advantages over the inks currently used, so it has managed to take its place in the sector in the best way possible. Being affordable and cheap, the security sector will be able to compete with gravure inks with high security benefits. This means a revolution in the growth of the security printing field and instead of the 10 million dollar market, it occupies the commercial and industrial field because packaged products are in urgent need of security and protection against counterfeiting and fraud.
The ink of the present invention has a strong coating during printing, the offset printing system is the most widespread, high quality, fastest and cheapest printing system in the world in this century and has managed to take the first place in quality. The inkjet digital offset printing system is no exception, because at the moment printing on inked paper is well established and produces absolutely excellent work, which is why it was decided to use the inventive ink in these printing systems. After printing with the aforementioned systems, the ink is wetted before drying and is fixed in the dry ink process of the present invention, in the process of the apparatus in which the dry ink of the present invention is impregnated and in the subsequent processes in the drying system such as UV & IR, and during this process, it becomes a very sticky, non-corrosive, fully dried and embossed ink in printing, which is also soft.
It is seen that the offset printing system is the best printing method in the world where the printing obtained according to the printing in the mentioned process will be flawless. In the explanations and forms made, embossed printing is used without requiring any special gravure plate and template for embossed printing, embossed printing is applied and is superior to the previous technique. This is due to the smooth and clean quality of the ink in the mentioned process, the dry ink absorbs the materials only in the parts of the material where the wet ink is present on the “same paper” and the reaction occurs during the baking and drying time. The material formed from the produced materials (inside the primex tank) melts and dries during baking, during which the action and reaction of the melting dry compound penetrates all layers of the paper material or anything else that can be printed. This creates the same outstanding print of high quality and durability, with high adhesion and anti-abrasion properties.
In prints made with the knowledge of gravure printing, there are problems such as slow drying after printing, which causes the ink to pass behind the top sheet and cause abrasion and wear on part of the embossed print, the presence of dots from the ink print on the upper part of the lower sheet and the printing of the back side of the upper sheet and deterioration of its quality. Thanks to the present invention, the quality of the products is increased and the desired products can be obtained in one time. Most importantly for manufacturers, waste during production is eliminated and costs are greatly reduced.
With the dry ink which is the subject of the present invention, all security inks can be used in appropriate conditions and in excellent quality to create a safer ground for existing inks and to prevent their counterfeiting by using their composition. The ink which is the subject of the present invention will make them more secure with the existing security compounds and using this new solution will leave the counterfeiters a few steps behind this technology, helping to save the lives of many people who are only in the field in this regard. This will prevent the production of counterfeit medicines and make the original packaging easy to recognize.
The present invention can also be used in Braille alphabets to provide the embossing feature and can be produced in alphabet papers (at least 150 grams) in one time on offset machines. Thanks to the double-sided alphabets, the cost is reduced and paper waste is prevented by using front and back pages on a single page (can be used on pages under 100 grams). Thus, the present invention can be easily used for disabled people.

Secondary Features compounds used in the secondary compositions of the document A printed security document consists of different parts. Each of them is a combination that plays an important role in its authenticity and ownership. After protecting the background from threats caused by fake attacks, it is time to print the original compositions in the secondary layer. The composition of this layer must also have high security properties to prevent any distortion. Properties such as visible clarity, readability, etc. make a security document unusual and different from normal documents and security documents with prior technologies, right down to the unique printing process before the ink of the present invention. Because with the present invention all these security inks will be able to increase their security and protection against counterfeiting several times, especially under the impression of the present invention. The types of security compounds and their use in previous security printing know-how used to date are described below.

The ink types used in the field of secure printing are:
1. Visible or Invisible Fluorescent Compounds: Text and image effects printed by this compound are invisible in normal light (colorless) and visible against the radiation of UV light rays.
2. Visible compounds: IR Visible/2D Invisible Inks this compound is one color in normal light and another color when exposed to long wavelength or infrared rays. This waterbased compound is fixed by UV drying. The visible colors of this compound are black, blue, red, orange, yellow and green, while the invisible colors are yellow, green, orange and blue.
3. Metallic compounds: Metallic High Reflectancy UV Curable Using this compound with gold or silver color spectra (using a UV curable) is a form of security defense against the advanced color scanners and copiers that abound on the market. When scanning images or color text printed with this ink, or when making a color copy, a dark image is produced due to the strong reflection of light. With a colorless metallic ink type, the image printed on the background of the document is hidden from normal light. Only after the document has been scanned or copied does the text or image appear, indicating that it is a copy or a forgery.
4. Multi-color compounds: (Metameric-Multi Interference color) Metameric inks have different colors when viewed in different lights due to their special properties. The image printed using this ink appears one color when viewed in standard light and another color when viewed in a different light. The technology used in the production of this composite series, called Pearlescent Pigment, is based on titanium dioxide and mica compounds. Physiologically, the pigments of such compounds are not harmful to human health and the environment and can be used for food packaging and children's toys. In addition, the pigments are insoluble in water and do not contain heavy metal compounds. There are many options for the color spectrum of this type of compound, with silver and gold being the most spectacular. Flexo, intaglio, screen and rotogravure printing systems are suitable for printing all kinds of UV compounds and the above solvent base.
5. Heat sensitive compounds: One of the distinguishing features of a thermochromatic compound is that it changes color when exposed to heat, especially when in contact with fingers. This compound immediately changes color when the temperature rises and returns to its original color when it falls. The simple and accessible method of testing the authenticity of thermal compounds made it very important. The color type and thermal color change range of thermochromic compounds are different according to different models of the manufacturer. Thermochromic compounds can also be used on substrates such as polyester, PVC and plastic, and due to the nature of their content, they are not prevented in the packaging of food, beverages, labels and children's toys. Suitable printing systems for this compound are flexo, rotogravure and screen printing. When these inks are used in combination with other patterns printed with other colored inks, a rainbow-like effect appears after heating the surface.
6. UV sensitive compounds: UV photochromatic, the amazing color change of such compounds, is different against different light rays. This series of composites, in which the fascinating color change can be observed in all types, is specific to a certain wavelength range and it is possible to print on different surfaces. A composite called LightTeil has color changes in the SOO-410 nm range. The color of this type of composite is exposed to the radiation of special lights and does not become fixed and permanent. The technique used for printing is screen and flexo.
7. OVI (Optically Varidble) compound sensitive to the angle of light irradiation: OVI compounds have a double color structure due to their special chemical structure.

Patterns printed with these inks show the first color when viewed directly and the second color when the viewing angle changes by 45 degrees. Color copies prepared from documents printed with OVI inks do not have these color changes in the desired graphic effects. Even very sensitive digital scanners cannot record this color change.
8. Compounds for grading with letterpress numberers: (Bleed Through) Security Numbering; scoring security inks are visible from the back of the paper after printing with mechanical or electromechanical metal embossing markers. The color of such ink may appear the same color as the back of the paper or a different color after it has penetrated the paper's inner tissue. This feature prevents fraudsters who rely on digital printers or numerators and normal compounds.
9. Visible and invisible short wavelength compounds: (Visible or Invisible Short Wavelength) Short wavelength compounds are formulated in the varnish or pigment of other security compounds and produce a night-like glow with a wavelength of 254 nm. The structure of this type of compounds is produced in solvent, blue and UV based and printed with flexo, rotogravure or screen printing systems.
10. Fluorescent blocking compound: (Fluorescent Block) Colorless and special uncoated compounds and blue-based, solvent-based and base formulas are available to block the glare of fluorescent effects caused by visible and invisible inks. Due to the very high absorption of infrared and ultraviolet rays by the compound, the coating varnish is completely transparent (against light transmission) and allows it to be applied over other compounds (without affecting the final color) using flexo, rotogravure, stencil and intaglio techniques.
11. Special compound for signature area: (Remove All Signature Panel) Inks with mechanical sensitivity to manipulation and distortion, are often used for printing signature area on credit cards.
12. Invisible phosphorescent compounds: (Invisible Phosphorescent) The unique effects of special phosphorescent pigments in the composition of this compound make it visible in a range of ultraviolet or infrared light. Copiers and scanners cannot capture the effects produced by this compound.
13. Color-shifting compounds: (Color Shifting) The structure of the pigments that make up this compound gives it a unique property. Its main characteristic is the color change according to the angle of irradiation of light, and this characteristic is not transferred when the document printed with this ink is scanned or copied. Flexo, intaglio, screen and rotogravure printing systems are suitable for printing all types of UV, solvent-based and oil-based inks. These compounds are available in different colors and can be ordered.

The present invention is a dry ink consisting of a composition of 10 different substances, and when used in printing processes, it reduces the cost and expands the area of use in safe printing due to its fast drying feature.

The structural and characteristic features and all the advantages of the present invention will be more clearly understood by means of the figures and the detailed description given below, and therefore this evaluation should be made by taking these figures and the detailed description into consideration.

### BRIEF DESCRIPTION OF THE DRAWINGS

FIG. 1: Schematic view of letterpress printing method

FIG. 2A: Schematic view of the embossed printing method

FIG. 2B: Schematic view of the application form of the embossed printing method

FIG. 3: View of the offset printing plate

FIGS. 4A-4D: Example illustrations of the changes in dry ink on a printed paper during the paper coating, drying and embossing processes to create embossed printing, wherein FIG. 4A shows compound particles, dry ink particles dispersed in it, example illustration of the “material” applied to the ink on the surface of the paper, FIG. 4B is an example illustration of particles gathering closer together as the liquid and vapors inside the particles evaporate,

FIG. 4C is an example illustration of particles deforming and becoming contiguous and tight, and FIG. 4D shows Polymer chains entangle beyond the boundaries and combine in the texture of the paper and particles form and are applied to the ink on the surface of the paper “material”

FIG. 5A: Back side, example illustration of paper deformation (inward protrusion) in the printed area

FIG. 5B: Front side, example illustration showing a wide range of embossing transfers and ink flow around the edges of the embossing

FIG. 5C: View of the removal of ink from the plate

FIGS. 6A-6C show example illustrations of the difference in quality between the embossed sample and the sample printed with the ink which is the subject of the present invention wherein FIG. 6A is an illustrative illustration of a sample printed with the ink which is the subject of the present invention, with no ink printed on the edges of the image, the image with filled holes and full coverage, and the image with a completely flat structure with no slippage on the outside, no tearing and no ink flow, FIG. 6B is an example illustration of a sample printed with the ink which is the subject of the present invention with completely smooth surfaces of excellent quality printed with the system disclosed in international patent application WO 2021/014296 A1 with embossed printing without ink tearing and ink flow, and FIG. 6C is an example illustration of a US dollar and an Arab rial banknote printed by a embossed gravure printing system with embossing, engraving plates, and expensive embossing presses with low embossing, very high creep ink

FIG. 7: Example illustration of the production process of security printing ink for embossed printing

FIG. 8: Example of the front side of the printed sheet after the intaglio printing process due to slow drying and humidity in embossed printing and intaglio inks

FIG. 9: Example of the back side of the printed sheet after the intaglio printing process due to slow drying and humidity in embossed printing and intaglio inks

### DETAILED DESCRIPTION OF THE INVENTION

The present invention relates to security embossed printing ink used for documents and packaging against forgery with embossed printing and is described in the following detailed description without limitation.

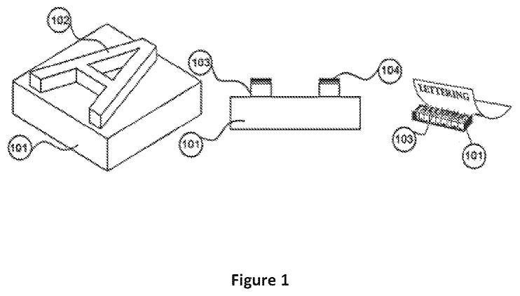

FIG. 1 shows the letter A (102) on a base (101). An inked section (104) is formed by a roller on the lettering (103) engraved on the base (101). In this way, the inked lettering (103) transfers the letters onto the paper by placing a sheet of paper. This process is called letterpress printing.

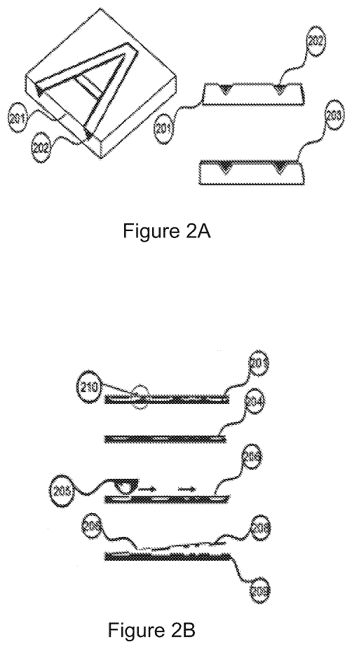

The engraved plate (201) in FIGS. 2A-2B is called intaglio. This engraved plate (201) is made of soft metal (copper) (steel). It is at least 0.5 and above in different thickness ranges. As the place where the image is engraved using different tools, the desired picture, pattern and writings will be engraved on the intaglio screen and will have a maximum depth of 0.3 mm. On the engraved plate (201), the text and images of the engraved plate (202) with maximum depth are engraved. The entire surface of this hollow engraved plate (201) is filled and coated with ink (203) by a roller. The excess ink is then removed from the engraved plate (201) with a so-called doctor blade. The ink remains only on the engraved part (204). The paper is then placed between the roller and the platen by a roller (205) with soft and hard coating. Due to the pressure on the roller-applied paper (206), the paper ejects the ink out of the pit (209) of the plate. Here, after the ink has dried and baked, the highlighted ink (208) is formed on the paper. This printing process is called intaglio printing.

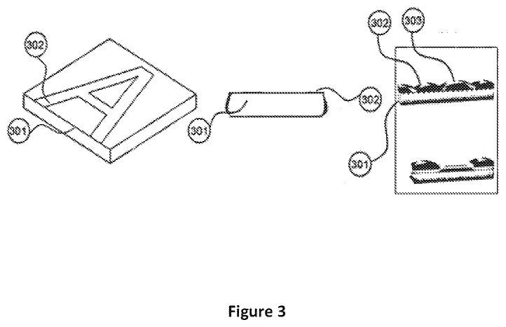

The plate in FIG. 3 is called a plate offset. This plate is used in offset printing machines. Offset printing system, also called lithography printing system, is today's latest and highest quality printing system. This plate consists of soft aluminum sheet. Of course, sometimes they are also made of soft copper. These plates are used in two ways:
1-Moist lithographic plate (301) (hydrophilic and hydrophobic)
2-Dry lithography plate (hydrophilic and hydrophobic) Only the case of a moist plate is described here. The maximum thickness of the lithographic plate is 0.35 mm and the minimum 0.1 mm. For text and images (302) of a moist lithographic plate there is no mention of a distinct and hollow carving. The micron layer is a delicate chemical material coated on the plate. The chemicals produced are sensitive to the water and alcohol combination (303) and the pH of the water is adjusted with a special water-repellent compound that does not mix with water. This is why the lithography plate is called hydrophilic and the lithography compound is called water repellent. This printing system is the best, highest quality and most profitable printing method used in the world. In the printing process using the existing plate (301), the parts where the chemicals remain (after the lithographic operation—which is done on the plate with a UV laser on the plate setters machine—the parts with the desired text and pattern are processed with a laser and the patterns and text remain, the rest of the directions are erased) and hydrophobic ink, the parts with the chemicals on the plate hold the ink with very high precision, while the remaining parts contain a mixture. The water and alcohol are absorbed and the images dipped in the ink are transferred to the paper in the offset printing system. This printing process is called offset printing (lithographic) and lithography plates are used.

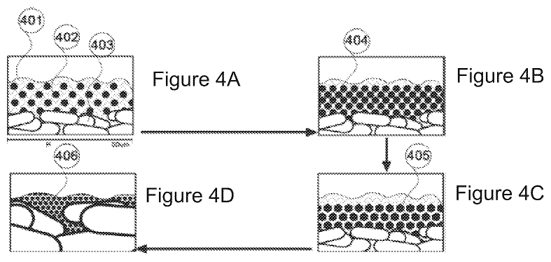

In the drawings of FIGS. 4A-4D, one millimeter images were magnified 80 times. In FIG. 4A, wet and adhesive offset printing ink (401) was printed on the magnified paper (403) shown in the figure as a microscopic image of the paper tissue. The inventive dry ink material (402) was distributed on the wet ink. As explained in FIG. 3, offset printing is the best and most common type of printing available and of the highest quality. This printing method was used in the trials of the ink which is the subject of the present invention. The printed image of this system is very precise and high quality, can be printed with very high accuracy and without error, and absorbs the material of whatever is printed on the paper. In the process of the printing system shown in FIG. 4B and described in the description, the wet ink printed on the material or paper (403) is placed in the process of the invented printing system and in the UV moment. Radiation, all vapors and moisture compounds evaporate very quickly (less than one second). After evaporation, the dry ink particles (404) become closer to each other as shown in FIG. 4B. In FIGS. 4C-4D, the wet ink carrying the dry ink particles (404) is placed in the process of the printing system disclosed in the international application WO 2021/014296 A1, and at the moment of application of UV radiation and vibration by the ultrasonic system, the wet compound material is simultaneously bonded together in a more cohesive manner. Moisture evaporates and gives an order specific to it. Here, regular ink particles (405) are formed and ink-impregnated materials (406) penetrate the paper and take their place in the permeable places. All these processes are carried out in less than a second and are finally fixed by UV radiation. During baking and drying, the drying system tunnel is placed in the system line and as a result of this process, the polymer chains of the dry ink material (402) of the present invention are intertwined. It blends into the texture of the paper, particles and ink to form a very durable and tactile, scratch-proof and permanent embossed print.

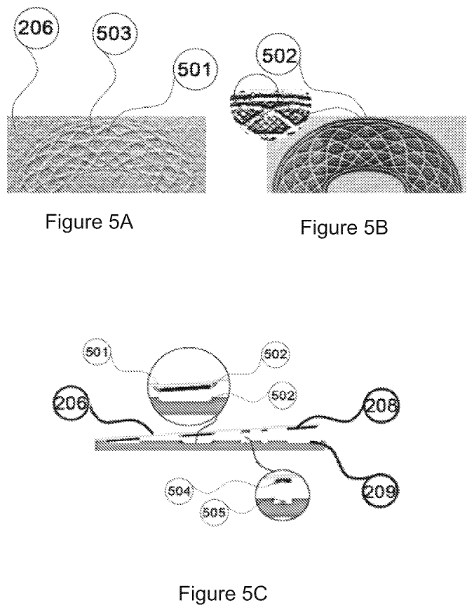

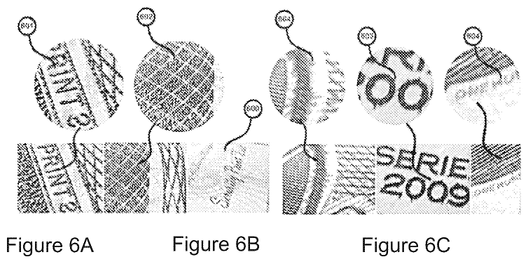

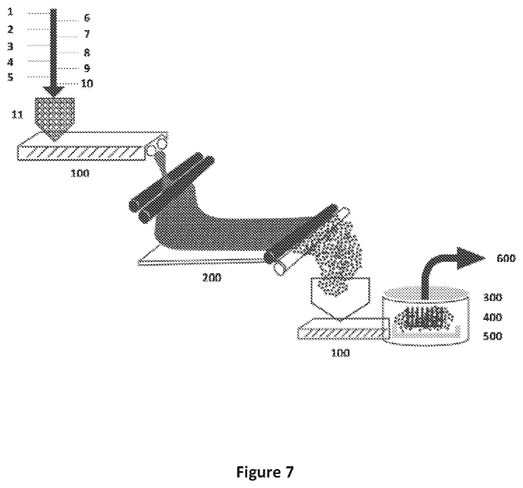

FIGS. 5A-5C show the ridges and depressions created on the back and front of the paper. This process takes place in the intaglio printing system. Here, the embossing process is applied by printing from the back side of the paper. The resulting embossing is achieved by pressing the paper from the back side. The 70% power of this embossing is due to this. The embossing (intaglio) printing system is illustrated in FIG. 2B: here the paper is placed between a roller with soft and hard coating (205) and the plate, and the roller-applied paper (206) is able to receive ink from the pit (209) of the paper plate due to the pressure created by the roller on the paper surface. After the ink has dried and baked, the highlighted ink (208) is formed on the paper. Explanation point: due to the pressure between the plate and the roller, the paper needs to be inserted into the pit (209) of the engraved plate (201) to absorb the ink. In the process, indentations (501) and ledges (503) appear on the paper. Also in this case, the pressure inside the engraving pit (209) in the plate and the part of the ink that adheres to a sheet of paper (504) and the part that remains inside the pit (505) are shown in FIG. 5C. In some cases, the ink is pushed out from the edges of the pit (502) by the pressure. In other cases, it is completely removed from the pit (209) and adhered to the paper. This process is created in cases where the design is smaller than usual, with small type and incomplete highlighting. An example of this is illustrated by the enlarged dollar (603) and Arabic rial (604) in FIGS. 6A-6C. Here, the leaks create a slight and illogical distribution of patterns and lettering. This is because the ink is wet and damp and contains moisture and vapor. The drying and hardening time of intaglio ink is more than 1 minute.

Most of the paper is made of linen and cotton. The moisture and vapor of the intaglio ink penetrates into the margins from the pit (209) outwards without leaving, and therefore penetrates into the margins of the patterns and text earlier and deteriorates the image and quality. It causes ink to flow (502) (603) on the edges and walls of the text and design. And the lower case letters of the micro-prints are not emphasized (605).

FIGS. 6A-6C show an example of the difference in the quality of the sample printed with the ink which is the subject of the present invention using the intaglio printing method. The image with no ink printed on the edges (601), the image with filled holes and full coverage (602), the sample (600) printed with the ink which is the subject of the present invention having a completely flat structure without slipping, tearing and ink flowing on the outside. It is an example illustration of the sample (600) printed with the ink which is the subject of the present invention, the surfaces of which are completely smooth with excellent quality, printed with the system disclosed in the international patent application WO 2021/014296 A1 with embossed printing without ink tearing and ink flowing.

FIG. 6C shows an example illustration of an enlarged dollar (603) and Arabic rial (604) banknote printed by an intaglio gravure printing system with intaglio engraving plates and expensive intaglio printing presses with low-embossing, very high creep ink.

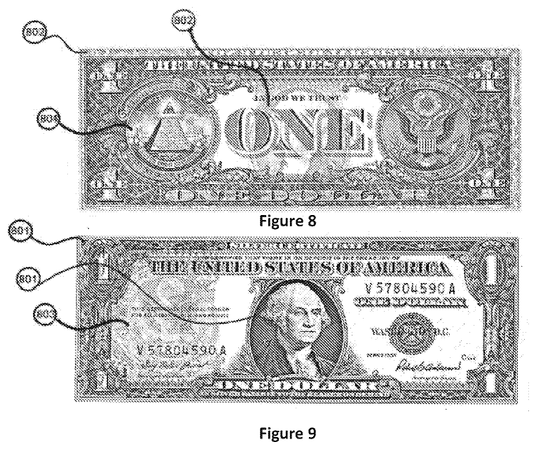

The drying time for embossing inks is approximately 1 minute as they dry slowly. During the printing process on an intaglio printer, a shadow image is transferred from one printed page to the back of the next printed page after the intaglio printing process. FIGS. 8 and 9 show an example of intaglio printing of a 1 dollar banknote. Printing defects are also associated with a lack of print quality. The shadow of the printed ink (802) has damaged the banknote, as can be seen in the image on the back of the banknote in FIGS. 8 and 9.

In FIG. 9, this damage is on the side of the banknote (801). Also in FIG. 9, this damage is on the left side of the banknote in the form of a return shadow (803). The image of this transferred return shadow (803) is on the back side of the banknote (804). All these cases are caused by the printed sheets piling up on each other due to slow drying and intaglio drying and poor baking.

The problems with the existing technique are described in detail above. In order to overcome these, the fast drying ink which is the subject of the present invention has been developed.

The printing ink of the present invention comprises 10 different substances and is used in dry form. Their percentage usage is as follows:
3-5% photopolymerization initiator,
1-3% filler materials,
40-45% polymer material (C2H4)n and (PE),
1-2% of at least one antistatic material mixture of chromium salts+salicylic acid+vinyl pyridine+methacrylate,
1-2% antioxidant material (masterbatch),
2-5% UV-blocking material such as Tinuvin 770,
20-25% aerosol such as Erosil or fumed silica,
Additive material with 1-3% Na2SO4 sodium sulfuric acid,
2-5% of at least one amine curing agent,
3-5% dry color pigment.

1. Photopolymerization Initiator: A material that can be cured by ultraviolet rays is a “starting material”. It is a material that can absorb radiant energy and produce active intermediates with the ability to polymerize the initiator through chemical changes. It is also an important component of any UV curing system. It is used where high intensity ultraviolet light is used to dry or fast dry inks. They are essential components of all UV curable adhesives, inks and coatings.

2. Filler material: They are used as additives and are widely used to reinforce polymers and improve properties such as dimensional stability and scratch resistance. Common examples of polymer reinforcement include: fibers (glass, carbon, polymer, etc.), fillers such as silica. In addition, fillers can either improve certain properties or make the product cheaper, or a combination of the two. Neutral materials are organic or inorganic. These materials are actually particles bound to resin and binders. Plastics, composites are added. Fillers can be solid, liquid or gaseous and are used without changing other properties of the polymer. Different polymer fillers used in plastics are: Alumina trihydrate, kaolin clay, calcium carbonate, barium sulfate, talc, etc. The most common fillers in the plastics industry are calcium carbonate, followed by talc and barium sulfate. These fillers significantly increase the strength and hardness of the products.

3. Polymer material: (C2H4)n and (PE): The most common polymers used in this process are: polyester, polyurethane, epoxy and acrylic, known as the chemical formulas (C2H4)n and (PE). Polyethylene is the most common plastic used today and is often abbreviated PE. Polyethylene is a type of polymer used primarily in packaging sector and powder coatings. In the present invention, thermoplastics are used and melted with heat (110 degrees Celsius). They solidify again when exposed to cold. It is used to heal surface damage, scratches, create hardness, smooth the surface and reduce gloss. This material is highly resistant to chemical attack. It has unique thermal stability and is very flexible in product formulation. Polyethylene wax can be either low density polyethylene (LDPE) or high density polyethylene (HDPE). In general, HDPE is denser and more crystalline.

4. Antistatic material: The non-conductivity of most polymers to electricity and their ability to absorb high static electricity causes the following problems in the production process. These problems include dust absorption and films sticking together, sparking when handling the product, causing fire due to discharge, and these situations are solved by adding antistatic. Its appearance is liquid and dark yellow. The chemical formula is a mixture of chromium salts+salicylic acid+vinyl pyridine+methacrylate. Kinematic viscosity at 40 degrees Celsius: 7 cSt and kinematic viscosity at zero degrees Celsius: 22 cSt. The solidification temperature (gelation) is below −39 °C. Antistatic Masterbatch is a type of antistatic material and is used to neutralize charges on the surface of the polymer. By using anti-static additives, problems such as dust, equipment damage, etc. caused by static electricity charges are reduced or eliminated.

5. Antioxidant material: Most polymers are oxidized by contact with air oxygen. Light and heat accelerate this oxidation. Antioxidant masterbatches are used to prevent the degradation of polymer chains during the process or during the use of the product. It is one of the most important additives in dry compounding processes. Generally, composites age rapidly under the influence of light, oxygen and heat, causing loss of strength, stiffness and flexibility, discoloration, scratching and loss of clarity. It stabilizes the polymer against oxidizing factors during the production process and prevents degradation and oxidation of the polymer at high process temperature.

6. An anti-UV material (optical stabilizer): The main purpose of using an anti-UV masterbatch is to protect polymer films against long-term damage caused by harmful solar radiation. There are materials such as Tinuvin 3261 Tinuvin P I Tinuvin 770 and Tinuvin 770 may be used in the present invention. Its chemical formula is C28H52O4N2. Its appearance is dry and its color is between white and cream. Tinuvin 770 anti-UV powder is another anti-UV grade. Anti-UV powder 770 is from the HALS category. HALS are amine-based optical stabilizers and are very effective stabilizers for polymers.

7. Aerosol: This material is used as a moisture retaining and anticondensation agent. The use of aerosol increases concentration and viscosity control, prevents precipitation, is used for filling and pouring materials, enhances gloss, improves clarity. It also helps to distribute the color more evenly on the printed surface. Aerosol is used as a dispersing agent when pigments are dispersed. All these factors make the print more transparent and glossy. Erosil or fumed silica, CAS number 112945-52-5. It is also known as pyrogenic silica. Because it is produced in a flame, it contains microscopic droplets of amorphous silica. It helps even and complete dispersion of pigments. Coatings are used to adjust the viscosity of the paint. The most important use of aerosol is as a thickening or concentrating agent. The viscosity of the liquid increases approximately.

8. Na2SO 4 additive, which is sodium sulfuric acid: Additives to polymers include a wide variety of chemicals. They are added to improve the polymer's properties, processing conditions or efficiency.

9. Amine curing agents, ammonia (NH3) derivatives:

The different types of curing agents used in the coating formulation are:
Amino type
Amidi type
Ceylon type
Isocyanate type
other cooking agents (arizidine, mercapto compounds . . . )

Amine curing agents are derivatives of ammonia (NH3). They are named according to the number of amines in a molecule. For example: mono, di, tri and polyamine. According to the type of related hydrocarbon, they are classified as follows:
Aliphatic/Cycloaliphatic/Aromatic/

Aromatic amines have better chemical resistance than aliphatic amines.

Aromatic curing agents are usually of the amine variety. Those that have been modified for further improvements, such as:
Increased chemical resistance
Effective on cooking time even at low temperatures
Good adhesion even on wet surfaces
Provides more container life.

10. A dry and powdery color pigment: Pigments are used to color paints, inks and other materials. Decolorizers are usually in the form of a fine powder. This powder is added to a relatively neutral or colorless material, such as a base color (or carrier), which keeps the pigment in suspension and transfers its adhesion and color to other materials. Colors (pigment) often have a special chemistry for use with very specific materials. It is a dry colored and fine powder. This powder is added to a relatively neutral or colorless adhesive.

The substances are combined in the specified proportions and the resulting mixture is polymerized, which improves its properties. In a production process where polymer granules are produced with other additives such as pigments, all the ingredients and other dry inks and liquids are mixed in mixers until they are completely homogeneous. This results in a color and creates the appearance characteristics of the dry ink. The desired mixture is put into the extrusion (100). During extrusion (100), several processes take place, often referred to as particle dispersion or distribution. These processes take place simultaneously.

In the production method which is the subject of the present invention; it is necessary to generate initial heat in extrusion (100) to ensure the melting of resin components, mixing and homogeneity of them, distribution of additives in the melt and wetting of resin components and pigments, disintegration of pigments bound to primary particles, melting of resin. However, during continuous production, the energy from the friction of the materials is sufficient to provide heat and the inner wall of the extruder must be kept cold to keep the temperature constant. The thin sheet materials coming out of the extruder need to be cooled quickly and crushed into chips for chipping (200) in the mill. The materials are chipped, finally ground (300) and screened (500) to form the final powder. The particles must be of the desired size to create a suitable surface finish and at the same time generate an electric charge. Commonly used for grinding (300) powder coatings are Pin disk mills, which include a built-in classifier to control the particle size. Here the particles are classified (400). Particles larger than the desired size are returned to the mill. A high volume fan draws air into the mill. This causes the release of heat and the transfer of dust particles. Particle size distribution can be controlled by controlling the particle residence time inside the mill and the speed of the classifier. The collection of dust is done by moving air through a cyclone. Particles above 10 microns and a small amount of smaller particles, depending on the efficiency of the cyclone, are removed and collected as a product. The dust leaving the cyclone is continuously screened before entering the packaging area to separate particles above the required size. It is also possible to collect all dust directly from the filter.

Due to the fact that the ink composition of the present invention is inexpensive and does not involve infrastructure costs such as embossing (intaglio) gravure plates and their use, it works very strongly in the printing and packaging industry. Printing with the ink which is the subject of the present invention is characterized by high print quality, durability, at least 10 times and more adhesion compared to intaglio ink. With the ink which is the subject of the present invention, the system can be borderless and edgeless and the number of colors is “unlimited” and it has the ability to combine and separate prints separately at the same time and it is possible to combine them.

Embossed printing is applied with the ink of the present invention and is superior. This is due to the smooth and clean quality of the ink in the said process, the dry ink absorbs the materials only in the parts of the material where the wet ink is present on the “same paper” and the reaction occurs during the baking and drying time. The material formed from the produced materials (inside the primex tank) melts and dries during baking, during which the action and reaction of the melting dry compound penetrates all layers of the paper material or anything else that can be printed. This creates the same outstanding print of high quality and durability, with high adhesion and anti-abrasion properties.

Dry ink which is the subject of the present invention can be used in dry offset and normal offset printing systems and inkjet offset digital printing systems to promote a wide market such as industrial and commercial packaging, food, pharmaceuticals, health, cosmetics, especially on paper and sheets. By creating embossed printing from “50 microns to 1000 microns” in large and small thicknesses, forgery is prevented by applying all security elements such as banknotes in packages with urgent security needs.

The technical and all other features mentioned in each claim are followed by a reference number, which reference number is used only to facilitate understanding of the claims and should not be considered as limiting the scope of the element indicated by this reference number for illustrative purposes.

It is clear that a person skilled in the art can also demonstrate the innovation in the present invention by using similar constructions and/or apply this structure to other areas with similar purposes used in the relevant art. Therefore, it is also obvious that such structures will lack the criterion of exceeding the novelty.

### REFERENCE NUMBERS

1. Photopolymerization Initiator
2. Filling material
3. Polymer material
5. Antioxidant material
6. Anti-UV material
7. Aerosol
8. Additive material
9. Curing agent
10. Color pigment
100. Extrusion
200. Chipping
300. Grinding
400. Classification
500. Screening
600. Obtaining Solid Composite Powder
101. Base
102. Letter A (embossed engraving)
103. Lettering (embossed engraving)
104. Inked Section
201. Engraved Plate
202. Text and Pictures of the Engraved Plate
203. Ink
204. After removing the excess ink from the plate, only the ink inside the engraving
205. Roller with Soft and Hard Coating 206. Roller Applied Paper
208. Highlighted Ink
209. Pit
210. Embossing ink applied completely smooth and evenly on the plate
301. Moist lithographic plate
302. Text and Images of a Moist Lithographic Plate
303. Water and Alcohol Combination
401. Offset printed ink
402. Dry Ink Material
404. Dry Ink Particles
405. Regular Ink Particles
406. Ink Impregnated Materials
501. Recess
502. Pit Edge
503. Ledge
504. Incomplete adhesion to paper
505. Missing part of the compound remaining inside the pit
600. Sample
601. Image without Ink Printed on the Edges
602. Full Coverage Image
603. One Dollar on Wall and on the edges of the writings, additional color with more errors, Ink bleeding
604. Arabic Riyal on Wall and on the edges of the writings, additional color with more errors, Ink bleeding
801. Side of the banknote
802. front side Shadow of Ink
803. back side Return Shadow
804. Back Side of the Banknote

1-16. (canceled)

17. A security embossed printing ink used for documents and packaging against forgery with embossed printing, wherein the ink comprises the following materials:
3-5% of at least one UV curable photopolymerization initiator,
1-3% of at least one filler material with thickening properties,
40-45% of at least one polymer material selected from the group consisting of polyester, polyurethane, epoxy, acrylic and polyethylene,
1-2% of at least one antistatic material, the antistatic material being a mixture of chromium salts, salicylic acid, vinyl pyridine, and methacrylate,
1-2% of at least one antioxidant material,
2-5% of at least one UV-blocking material,
20-25% aerosol as at least one moisture-retaining and anti-condensation material,
1-3% Na2SO4,
2-5% of at least one amine curing agent,
3-5% of at least one dry and powdery color pigment.

18. The security embossed printing ink used for documents and packaging against forgery with embossed printing according to claim 17, wherein said at least one UV curable photopolymerization initiator is solvent-free and does not change the texture of a paper so that the ink is fixed on the paper surface and does not corrode.

19. The security embossed printing ink used for documents and packaging against forgery with embossed printing according to claim 17, wherein the at least one filler material contains at least one of fibers and silica, in particular wherein the fibers are selected from the group consisting of glass fibers, carbon fibers and polymer fibers.

20. The security embossed printing ink used for documents and packaging against forgery with embossed printing according to claim 17, wherein the at least one polymer material includes at least one of polyester, polyurethane, epoxy, acrylic and combinations thereof.

21. A method for the production of security embossed printing ink used for documents and packaging against forgery with embossed printing, the method comprising the following steps:
mixing an ink composition containing 3-5% of at least one UV curable photopolymerization initiator, 1-3% of at least one filler material with thickening properties, 40-45% of at least one polymer material selected from the group consisting of polyester, polyurethane, epoxy, acrylic and polyethylene, 1-2% of at least one antistatic material, the antistatic material being a mixture of chromium salts, salicylic acid, vinyl pyridine, and methacrylate, 1-2% of at least one antioxidant material, 2-5% of at least one UV-blocking material, 20-25% aerosol as at least one moisture-retaining and anti-condensation material, 1-3% Na2SO4, 2-5% of at least one amine curing agent, and 3-5% of at least one dry and powdery color pigment, until a completely homogeneous mixture is obtained,
putting the obtained mixture in an extruder,
cooling of the material coming out of the extruder,
chipping the cooled material into chips,
grinding of the obtained chips in a mill,
screening of the ground chips, and
obtaining a solid composite powder from the screened and pulverized mixture.

22. The method for the production of security embossed printing ink used for documents and packaging against forgery with embossed printing according to claim 21, wherein the solid composite powder is for use as an intaglio printing ink.

23. The method for the production of security embossed printing ink used for documents and packaging against forgery with embossed printing according to claim 21, wherein the mill used for grinding is a pin disk mill.

24. A document to which the security embossed printing ink according to claim 17 is applied, wherein said document is a security document, a passport, an identity document, a diving license, a banknote, a stock certificate, a tax stamp, an excise stamp or a security label.

25. Use of aerosol in a security embossed printing ink used for documents and packaging against forgery with embossed printing according to claim 17 for fast drying and thickening of the security embossed printing ink on a paper surface.

26. Use of at least one UV-curable photopolymerization initiator in a security embossed printing ink used for documents and packaging against forgery with embossed printing according to claim 17 to prevent the security embossed printing ink from casting shadows on the back surface of a paper.
